(19) United States
(12) Patent Application Publication
(10) Pub. No.: US 2009/0122173 A1
(43) Pub. Date: May 14, 2009

(54) LOW NOISE READOUT APPARATUS AND METHOD FOR CMOS IMAGE SENSORS

(76) Inventors: William Emerson Tennant, Thousand Oaks, CA (US); Stefan Clemens Lauxtermann, Camarillo, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/939,518

(22) Filed: Nov. 13, 2007

(51) Int. Cl. H04N 5/335

(52) U.S. Cl. 348/308; 348/E05.091

(57) ABSTRACT

A low noise readout apparatus and method for CMOS image sensors having a complementary metal oxide semiconductor with a plurality of pixels, each pixel having a charge-generating unit configured to release a charge, a potential well for receiving the released charge from the charge-generating unit, a first gate, a second gate and a floating gate, in series and adjacent the potential well, the first gate transfers the charge from the potential well to the second gate, the second gate transfers the charge to the floating gate to generate a first corresponding readout voltage, the first gate, the second gate and the floating gate transfer the charge back and forth, at least once, to generate at least a second corresponding readout voltage, and a readout circuit coupled to the floating gate, the readout circuit measures a voltage corresponding to the charge transferred to the floating gate.

### BACKGROUND

This disclosure relates to the CMOS image sensors. More particularly, the invention relates to low noise readout apparatus and method for CMOS image sensors.

### SUMMARY

A low noise readout apparatus having a complementary metal oxide semiconductor with a plurality of pixels, each pixel having a charge-generating unit configured to release a charge, a potential well for receiving the released charge from the charge-generating unit, a first gate, a second gate and a floating gate, in series and adjacent the potential well, the first gate transfers the charge from the potential well to the second gate, the second gate transfers the charge to the floating gate to generate a first corresponding readout voltage, the first gate, the second gate and the floating gate transfer the charge back and forth, at least once, to generate at least a second corresponding readout voltage, and a readout circuit coupled to the floating gate, the readout circuit measures a voltage corresponding to the charge transferred to the floating gate. In one embodiment, the low noise readout apparatus further includes an output circuit selected from a group consisting of an averaging circuit and an accumulation circuit, the averaging circuit is configured to average the first corresponding readout voltage and the at least second corresponding readout voltage and outputs an average voltage, the accumulation circuit is configured to sum the first corresponding readout voltage and the at least second corresponding readout voltage and outputs a total voltage.

According to a feature of the present disclosure, a method for reducing noise readout in an image sensor is disclosed. The image sensor having a charge-generating unit, a potential well, a first gate, a second gate, a floating gate and a readout circuit. The method includes initializing the floating gate using a predetermined voltage potential from the readout circuit, generating a charge when light strikes the charge-generating unit, altering the depth of the potential well using the generated charge, generating a first charge replica in the potential well using a fill and spill mechanism, transferring the first charge replica from the potential well, across the first gate, the second gate, and the floating gate to generate a first corresponding readout voltage, transferring the first charge replica back and forth, at least once, from the floating gate to the first and second gates to generate at least a second corresponding readout voltage, and averaging the first corresponding readout voltage and the at least second corresponding readout voltage to obtain a first average readout voltage.

In one embodiment, the method further includes generating a second charge replica in the potential well using the fill and spill mechanism, transferring the second charge replica from the potential well, across the first gate, the second gate, and the floating gate to generate a third corresponding readout voltage, transferring the second charge replica back and forth, at least once, from the floating gate to the first and second gates to generate at least a fourth corresponding readout voltage, averaging the third corresponding readout voltage and the at least fourth corresponding readout voltage to obtain a second average readout voltage, averaging the first average readout voltage and the second average readout voltage to obtain a resultant average readout voltage, and outputting the resultant average readout voltage from the readout circuit.

According to a feature of the present disclosure, a low noise readout image sensor is disclosed. The low noise readout image sensor having a complementary metal oxide semiconductor with a charge-generating unit configured to release a charge, a potential well, whose depth is defined by the amount of charge generated in an electrically connected light sensing device, for receiving the released charge from the charge-generating unit, a charge-transporting circuit and a readout circuit, the readout circuit is coupled to the charge-transporting circuit to measure a voltage corresponding to the charge transferred to the charge-transporting circuit, the charge-transporting circuit having a first gate, a second gate and a floating gate, the charge-transporting circuit is configured to generate a first charge replica in the potential well using a fill and spill mechanism, transfer the first charge replica from the potential well, across the first gate, the second gate, and the floating gate to generate a first corresponding readout voltage in the readout circuit, and transfer the first charge replica back and forth, at least once, from the floating gate to the first and second gates to generate at least a second corresponding readout voltage in the readout circuit, and an averaging circuit for averaging the first corresponding readout voltage and the at least second corresponding readout voltage to obtain a first average readout voltage.

In one embodiment, the charge-transporting circuit may be further configured to generate a second charge replica in the potential well, whose depth is defined by the amount of charge generated in an electrically connected light sensing device, using the fill and spill mechanism, transfer the second charge replica from the potential well, across the first gate, the second gate, and the floating gate to generate a third corresponding readout voltage, and transfer the second charge replica back and forth, at least once, from the floating gate to the first and second gates to generate at least a fourth corresponding readout voltage. The averaging circuit may be configured to average the third corresponding readout voltage and the at least fourth corresponding readout voltage to obtain a second average readout voltage, and average the first average readout voltage and the second average readout voltage to obtain a resultant average readout voltage.

### DRAWINGS

The above-mentioned features and objects of the present disclosure will become more apparent with reference to the following description taken in conjunction with the accompanying drawings wherein like reference numerals denote like elements and in which:

FIG. 1 is a low noise readout apparatus for a complementary metal oxide semiconductor, according to one embodiment of the present invention.

FIGS. 2-7 illustrate charge transport in the low noise readout apparatus of FIG. 1, according to an embodiment of the invention.

FIG. 8 is an exemplary flow chart outlining the operation of the low noise readout apparatus of FIG. 1, according to one embodiment of the present invention.

FIG. 9 illustrates a capacitive divider circuit diagram for the low noise readout apparatus of FIG. 1, according to an embodiment of the invention.

FIG. 10 is a low noise readout apparatus for a complementary metal oxide semiconductor with a separate reset transistor and a charge drain for charge-generating unit, according to one embodiment of the present invention.

FIG. 11 is a low noise readout apparatus of FIG. 10 with a deep p implant, according to one embodiment of the present invention.

FIG. 12 is a low noise readout apparatus for a complementary metal oxide semiconductor with a photogate and a charge drain for the charge-generating unit, according to one embodiment of the present invention.

FIG. 13 is a low noise readout apparatus of FIG. 12 with a deep p implant, according to one embodiment of the present invention

FIG. 14 is a low noise readout apparatus for a hybrid image sensor, according to one embodiment of the present invention.

FIGS. 15-20 illustrate the charge transport in the low noise readout apparatus of FIG. 14, according to an embodiment of the invention.

FIG. 21 is an exemplary flow chart outlining the operation of the low noise readout apparatus of FIG. 14, according to one embodiment of the present invention.

FIG. 22 is an exemplary flow chart outlining the operation of the low noise readout apparatus of FIG. 14, according to another embodiment of the present invention.

### DETAILED DESCRIPTION

In the description that follows, the present invention will be described in reference to a preferred embodiment that that provides low light level detection capabilities in CMOS image sensors. The present invention, however, is not limited to any particular imaging application nor is it limited by the examples described herein. Therefore, the description of the embodiments that follow are for purposes of illustration and not limitation.

Photodiodes and photogates are charge-generating units used in digital imaging devices for converting optical signals into electrical signals. For example, a pinned photodiode may be used to produce and integrate photoelectric charges generated in CMOS image sensors. The charge-generating units may be arranged in linear or planar arrays with a plurality of photosensitive sensors, generally designed as pixels, on a semiconductor chip. Each pixel generates an output signal representing the amount of light incident on the pixel.

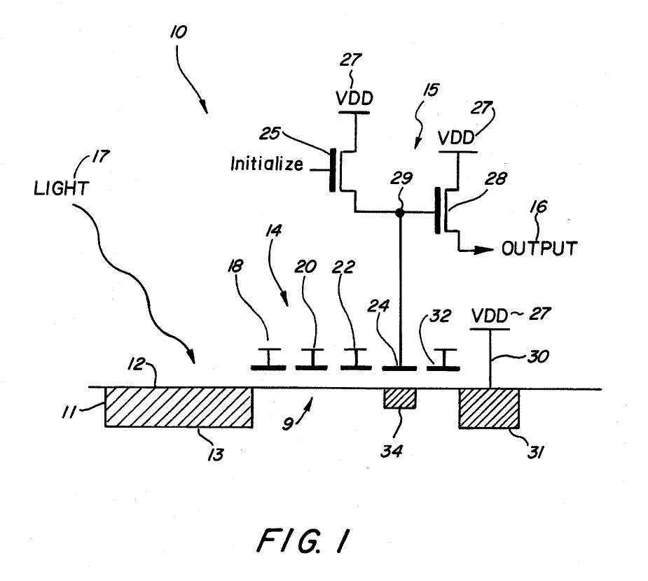

FIG. 1 is a low noise readout apparatus 10 for a complementary metal oxide semiconductor, according to one embodiment of the present invention. The complementary metal oxide semiconductor may include a plurality of pixels, each pixel having a charge-generating unit 12, a charge-transporting circuit 14, a readout circuit 15 and an output circuit 16.

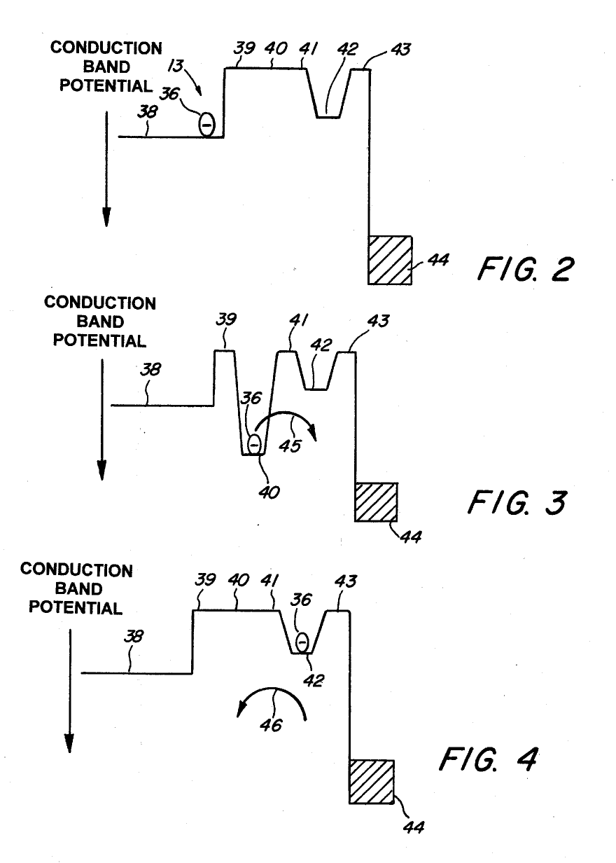

The charge-generating unit 12 may include a photodiode, an avalanche photodiode, a pinned photodiode and a photo gate. The charge-generating unit 12 may be configured to release a charge when light 17 strikes the unit 12. The released charge alters the depth of a potential well 13 adjacent the charge-generating unit 12, as shown in FIG. 2. The charge-generating unit 12 may be coupled to readout circuit 15 via the charge-transporting circuit 14.

The charge-transporting circuit 14 may include a plurality of gates or electrodes to transport charge across the low noise readout apparatus 10. For example, the charge transporting circuit 14 may include a first gate 20, a second gate 22 and a floating gate 24. In one embodiment, the charge transporting circuit 14 may also include a third gate 18. The gates 18, 20, 22 and 24 may be aligned in series and adjacent the potential well 13. The first gate 20 may be configured to transfer charge from the potential well 13 to the second gate 22. The second gate 22 transfers the charge to the floating gate 24. The third gate 18 may be used to isolate the charge at the first gate 20 from the potential well 13. Typically, such a charge-transporting circuit may be referred to as Charge Coupled Device, abbreviated CCD. The charge-transporting circuit 14 may be, but is not limited to, a surface channel or a buried channel CCD with no implants in between electrodes. It may be fabricated using abutting or overlapping poly-silicon electrodes. In one embodiment of the present invention, it may also be a transistor chain.

The floating gate 24 is preferably initialized using a predetermined voltage potential from the readout circuit 15. The readout circuit 15 may include a reset transistor 25, a supply voltage 27 and a source follower transistor 28. The reset transistor 25 initializes the floating gate 24 using the supply voltage 27. After initialization, charge is transferred from charge-generating unit 12 to the floating gate 24, where it causes a potential change at node 29. The difference between the supply voltage 27 and the potential change at node 29 provides a corresponding readout voltage that is outputted to the output circuit 16 via source follower transistor 28. The second gate 22 transfers charge to the floating gate 24 to generate a first corresponding readout voltage. The first gate 20, the second gate 22 and the floating gate 24 transfer the charge back and forth, at least once, to generate at least a second corresponding readout voltage.

In one embodiment, the output circuit 16 may include an averaging circuit (not shown) and an accumulation circuit (not shown). The averaging circuit may be configured to average the first corresponding readout voltage and the at least second corresponding readout voltage and outputs an average voltage via the source follower transistor 28. The accumulation circuit (not shown) may be configured to sum the first corresponding readout voltage and the at least second corresponding readout voltage and outputs a total voltage via the source follower transistor 28. Once the average voltage or the total voltage is outputted by the source follower transistor 28, charge may be drained from the low noise readout apparatus 10 using a charge drain 30 with reset gate 32. Charge drainage may be actuated by coupling the charge drain 30 to a high potential, such as supply voltage 27. This clocks the reset gate 32 to high, which allows the charge to flow from the floating gate 24 to the charge drain 30.

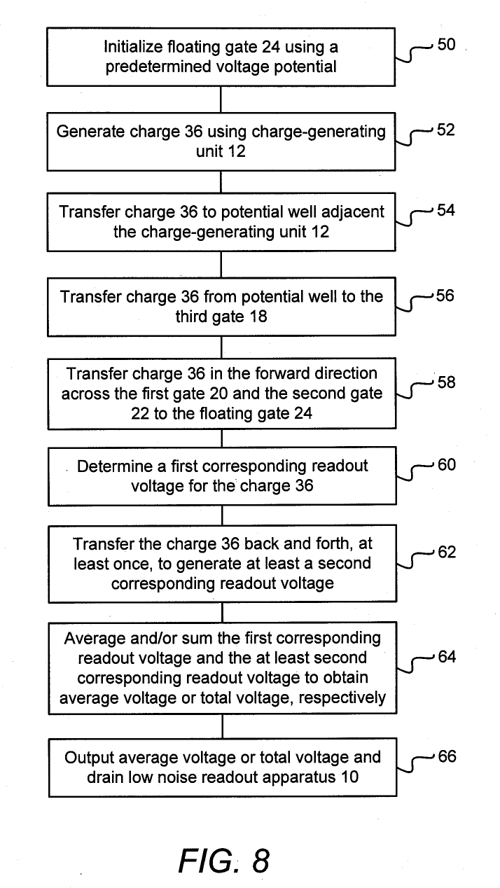

FIGS. 2-8 illustrate the charge transport in the low noise readout apparatus 10, according to an embodiment of the invention. First, the floating gate 24 is initialized using a predetermined voltage potential (50). Next, the charge-generating unit 12 generates a charge 36 when light 17 strikes the unit 12, as shown in FIG. 2 (52). The generated charge 36 alters the potential well 13 adjacent the charge-generating unit 12 (54). In one embodiment, the charge-generating unit 12 collects charge 36 while maintaining a fixed or pinned Fermi level 38. Regardless of the potential next to the Fermi level 38 of the charge-generating unit 12, the Fermi level 38 does not change. FIG. 2 also shows the initial potential underneath the first gate 20, the second gate 22, the third gate 18, the floating gate 24, the reset gate 32 and the charge drain 30.

Next, the third gate 18 is activated, for example, by supplying a voltage for a predetermined period. This voltage attracts the charge 36 to move underneath the third gate 18 (56). Since the applied voltage increases the quasi-Fermi level 39 of the third gate 18 by creating a well at a level higher than the pinned Fermi level 38, charge 36 cannot move back to the charge-generating unit 12. In FIG. 3, the first gate 20 is activated by applying a positive voltage for a predetermined period. The voltage applied to the first gate 20 is preferably greater than or equal to the voltage applied to the third gate 18. The voltage applied to the first gate 20 attracts the charge 36 to move underneath the first gate 20. The applied voltage increases the quasi-Fermi level 40 of the first gate 20 to allow charge to distribute under both the third gate 18 and the first gate 20. Next, the applied voltage for the third gate 18 is set to zero. This resets the potential of the third gate 18 and collapses the well 39 underneath the third gate 18. Since the third gate 18 is still activated, the quasi-Fermi level 40 of the first gate 20 will be higher than the quasi-Fermi level underneath the third gate 18 and the charge-generating unit 12. Consequently, the charge 36 underneath the third gate 18 moves across and remains underneath the first gate 20. Hence, the third gate 18 isolates the charge 36 from the charge-generating unit 12 and the second gate 22 isolates the charge 36 from the floating gate 24, as shown in FIG. 3.

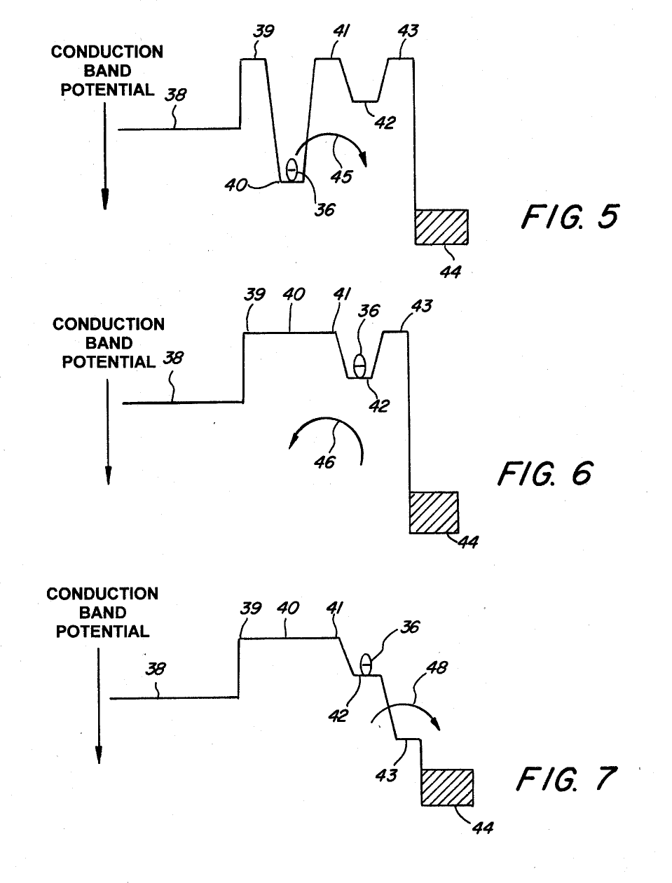

This process is repeated until the charge 36 is moved in a forward direction 45 across the first gate 20 and the second gate 22 to the floating gate 24 (58). The floating gate 24 is electrically connected to the node 29. The difference between the supply voltage 27 and the potential change at node 29, caused by the signal charge underneath electrode 24, provides a first corresponding readout voltage that is kept in the voltage domain of a column parallel amplifier (not shown) (60). FIG. 4 shows the floating gate 24 transferring the charge 36 in a backward direction 46 towards the first gate 20. In one embodiment, the charge 36 is removed from the sense node 29 and transferred back to the first gate 20. Then, in FIG. 5, the potential underneath the floating gate 24 is measured again without the charge 36, providing a measurement of the noise level prior to reading the signal charge the second time. This readout technique is known in the art as Correlated Double Sampling, abbreviated CDS.

The charge 36 is then moved in the forward direction 45 across the second gate 22 to the floating gate 24. The floating gate 24, being electrically connected to the node 29, generates a second corresponding readout voltage. As shown in FIG. 6, the low noise readout apparatus 10 may be configured to transfer the charge 36 back and forth, at least once, to generate at least a second corresponding readout voltage (62). The first corresponding readout voltage and the at least second corresponding readout voltage may be averaged to obtain a first average readout voltage or summed to obtain a first accumulated readout voltage (64). When the charge is transferred back to the first gate 20, the potential underneath the floating gate 24 is measured again without the charge 36 to determine the offset noise level. This subtraction readout technique is equivalent to a CDS readout and eliminates Fixed Pattern Noise, FPN, kTC noise and reduces 1/f noise contributions.

The measured noise levels may be interpreted as a random threshold voltage fluctuation over time. In one embodiment, such threshold voltage fluctuations may be removed by determining a statistical signal average by measuring corresponding readout voltages multiple times. When the charge 36 is transferred back to the first gate 20, a new noise level is established for node 29. Even though the noise level is fluctuating, by measuring the change in voltage at node 29 due to the charge 36, the threshold voltage fluctuations are suppressed and the charge 36 at the floating gate 24 can be measured multiple times without an increasing the 1/f noise integration bandwidth. This is possible because the change in voltage due to charge 36 is rapid compared to changes in voltage due to 1/f noise. Because charge 36 was measured, at least twice, with the same statistically averaged noise, the signal to ratio is improved by at least a factor √2.

In one embodiment, Correlated Double Sampling (CDS) may be used for every measurement. Because measurement time is increased by transferring the charge 36 back and forth, the accuracy in measuring a corresponding readout voltage increases. The CDS readout for every sub-sample can be understood as a frequency modulation where a low frequency measurement is transferred to high frequency levels, ideally above the 1/f noise knee. Since the signal is integrated over a long period of time, low noise readout apparatus 10 may be configured to narrow band around the modulated high frequency levels above 1/f noise, thereby providing an improvement in signal to noise ratio. In one embodiment, the charge 36 is transferred back and forth from the floating gate 24 until the low noise readout apparatus 10 reaches a physical limit where the readout is essentially noise free, only containing shot noise of charge 36 generated by the charge-generating unit 12.

In FIG. 7, once the average voltage or the total voltage is outputted by the source follower transistor 28, charge 36 may be drained from the low noise readout apparatus 10 using the charge drain 30 with reset gate 32 (66). For example, after a predetermined number of readout sequences are reached in the apparatus 10, charge 36 is drained by coupling the charge drain 30 to a high potential, such as supply voltage 27. Therefore, the reset gate 32 is clocked to high, which allows the charge to flow in direction 48 from the floating gate 24 to the charge drain 30. The predetermined number of readout sequences may be ascertained by comparing the averaged or accumulated readout voltage of the column parallel amplifier with a preset value, i.e. below the saturation level of the column parallel amplifier. This will make it possible to determine if further sampling is possible to further decrease noise. In one embodiment, the column parallel amplifier (not shown) may be configured to determine automatically if further sampling is needed. In this implementation, the complete image sensor will provide a very wide dynamic range.

Referring back to FIG. 1, the floating gate 24 may include an implant 34, for example, a shallow p implant, to pin the Fermi level of the semiconductor underneath the floating gate 24. Such a pinning or partial pinning may be implemented to accelerate the charge removal away from the floating gate in direction 46, as shown in FIG. 6. In one embodiment, low noise readout apparatus 10 may also include an implant 11 underneath the charge-generating unit 12. The implant 11 may be a gradient with shallow p doping by the surface and slight n doping underneath. The p doping may be used to push the charge 36 down into the substrate 9, while the n doping may be used to modulate the threshold voltage at the charge-generating unit 12. Furthermore, the low noise readout apparatus 10 may also include an N+doped implant 31 underneath charge drain 30.

FIG. 9 illustrates a capacitive divider circuit diagram as an equivalent circuit representation for the low noise readout apparatus 10. The circuit diagram 67 includes capacitor (C1) 68, capacitor (C2) 70, and capacitor (C3) 72. Capacitor 68 may be equivalent to parasitic capacitance in and around the low noise readout apparatus 10. Capacitor 70 may be equivalent to the capacitance between the floating gate 24 and the surface of the substrate 9 or surface of implant 34. Capacitor 72 may be equivalent to capacitance from the floating gate 24 to the substrate 9. Preferably, capacitor 70 has greater capacitance than capacitors 68 and 72. Charge 36 enters the capacitive divider circuit diagram 67 between capacitor 70 and capacitor 72. The charge is subsequently measured via voltage 75, i.e. the gate source voltage VGS that will establish across the gate source terminals of source follower transistor 28. The capacitive divider circuit diagram 67 includes ground 74 and 76, ground 74 is equivalent to the substrate 9 and ground 76 may be a supply voltage or a ground but will in any case establish a virtual ground. A gate source voltage 75 in the capacitive divider circuit may be readout using the source follower transistor 28.

Based on the equivalent capacitive divider circuit representation in diagram 67, the amount of photo-generated charge can be calculated from the output voltage. This information can then be used to determine if further sampling is needed to increase the signal to noise ratio (SNR). In one embodiment, the SNR may be computed on chip to determine if further sampling is needed. For example, as long as the noise is dominated by readout noise, i.e. not photon shot noise, to double the SNR, the charge 36 may be sampled four times. Similarly, the output signal of the column parallel amplifier may be evaluated to determine if the voltage saturation limit is reached. In that case, the SNR is determined by photon shot noise and nothing can be gained by further over sampling. This evaluation of the output signal at the column amplifier level is equivalent to a partial digitization and will help to extend the dynamic range of the CIS.

As can be envisioned by a person skilled in the art, the low noise readout apparatus 10 may provide ultra low light level imaging with sub-electron noise. In one embodiment, the low noise readout apparatus 10 may be used to provide night vision instrumentation for cameras. In another embodiment of the invention, the readout apparatus 10 may be used in high frame rate image sensors or to capture images at very short integration times. This will, for example, make it possible to capture images of fast moving objects without image blurr. If on the other hand the camera platform is not stationary but shaking or vibrating at high frequencies or large amplitudes, the integration time may be reduced accordingly. Because the readout apparatus 10 can detect signals as low as one single electron, the small amount of charge generated during the very short integration time can be used to create a distortion free image. Therefore, a camera using a readout apparatus 10 will be more tolerant to camera shake as, for example, encountered in small airborne systems.

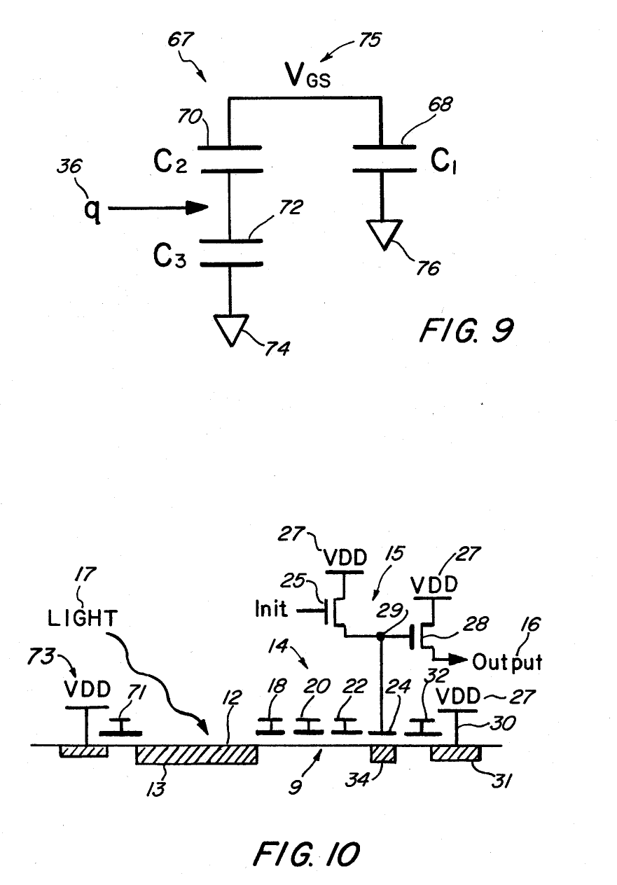

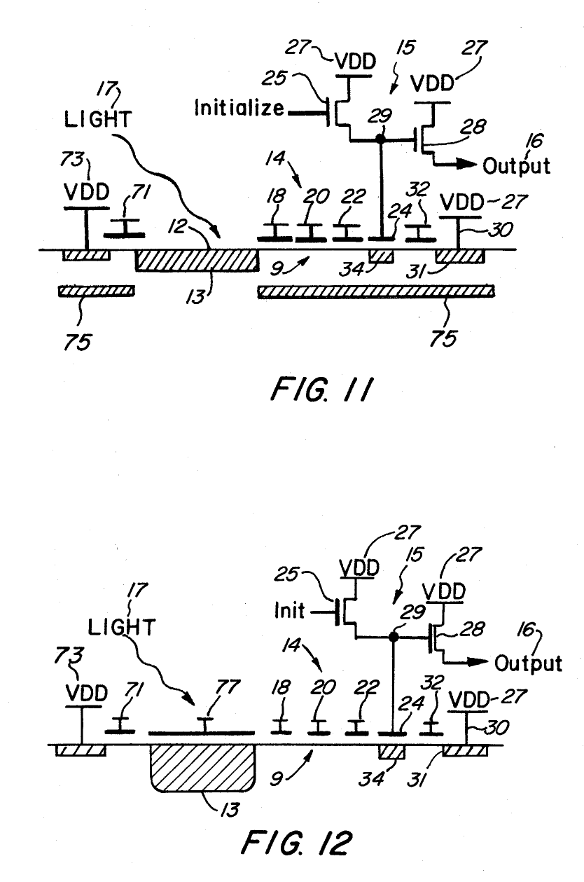

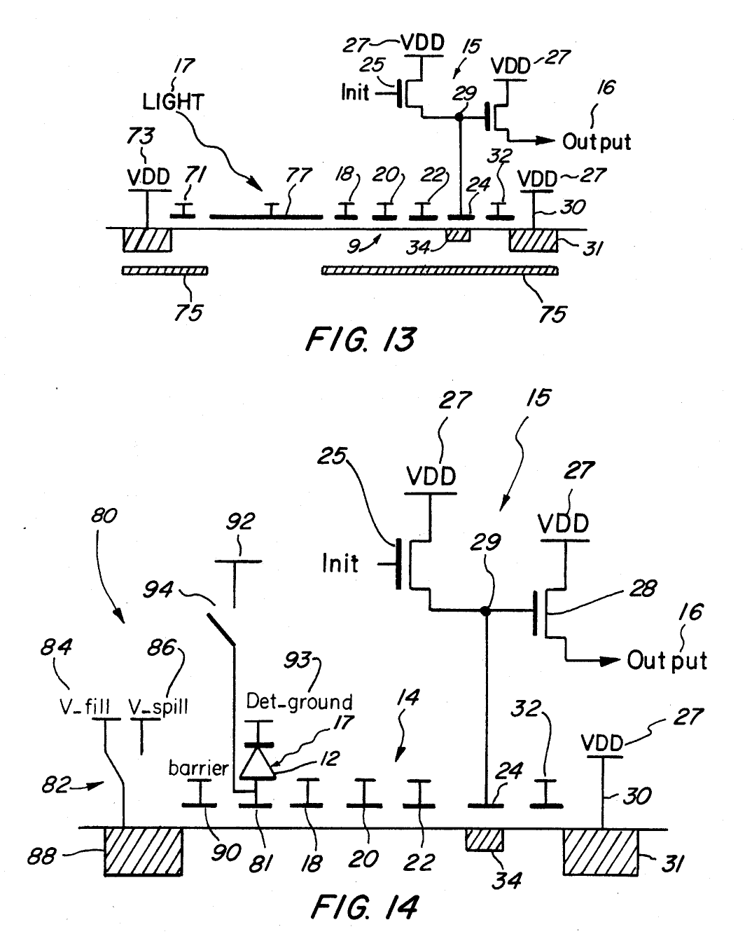

As shown in FIG. 10, the low noise readout apparatus 10 may include a separate reset transistor 71 and a charge drain 73 for the charge-generating unit 12. According to one embodiment of the present invention, the low noise readout apparatus 10 may include a deep p implant 75 to shield the first gate 20, the second gate 22, the third gate 18 and the floating gate 24 from parasitic charge integration, as shown in FIG. 11. As can be envisioned by a person skilled in the art, the charge-generating unit 12 may be a photogate. FIG. 12 illustrates a low noise readout apparatus for a complementary metal oxide semiconductor with separate reset transistor 71 and charge drain 73 for a photogate 77, according to one embodiment of the present invention. Charge 36 in the potential well 13 underneath the photogate (PG) 77 is first integrated (PG=1), then is transferred out of the photogate 77 by collapsing the potential well 13 (PG=0). The potential well may be created underneath potential well 13 to start integration of the next frame (PG=0), then the next frame can be integrated while readout of the previous frame is on-going. The charge 36 is transferred back and forth, to measure corresponding readout voltage and then charge 36 is drained to reset the low noise readout apparatus. According to one embodiment of the present invention, the low noise readout apparatus 10 of FIG. 12 may include a deep p implant 75 to shield the first gate 20, the second gate 22, the third gate 18 and the floating gate 24 from parasitic charge integration, as shown in FIG. 13.

FIG. 14 is a low noise readout apparatus 80 for a hybrid Focal Plane Array (FPA), according to one embodiment of the present invention. The FPA may include a first wafer hybridized to a second wafer (not shown) using, for example, indium bump contacts that provide electrical contact and mechanical structure. Epoxy may be used to fill the gap formed by indium bump contacts between the first wafer and the second wafer. The epoxy also provides further structural support to couple the first wafer to the second wafer.

The first wafer may include one or more charge-generating units 12 configured to release charge when light 17 strikes the unit 12. The first wafer may also include a detector ground 93 to facilitate initialization of the charge-generating unit 12. The first wafer may be a semiconductor compound or alloy from groups 2 and 6 of the periodic table, semiconductor compound and alloy from groups 4 and 6 of the periodic table, semiconductor compound, element or alloy from group 4 of the periodic table, semiconductor compound and alloy from groups 3 and 5 of the periodic table. For example, the first wafer may be mercury telluride (HgTe), silicon carbide (SiC), or any material that releases charge when struck by light of predetermined band region. The second wafer may include a potential well creating electrode 81, charge-transporting circuit 14 and readout circuit 15. The second wafer may also include output circuit 16.

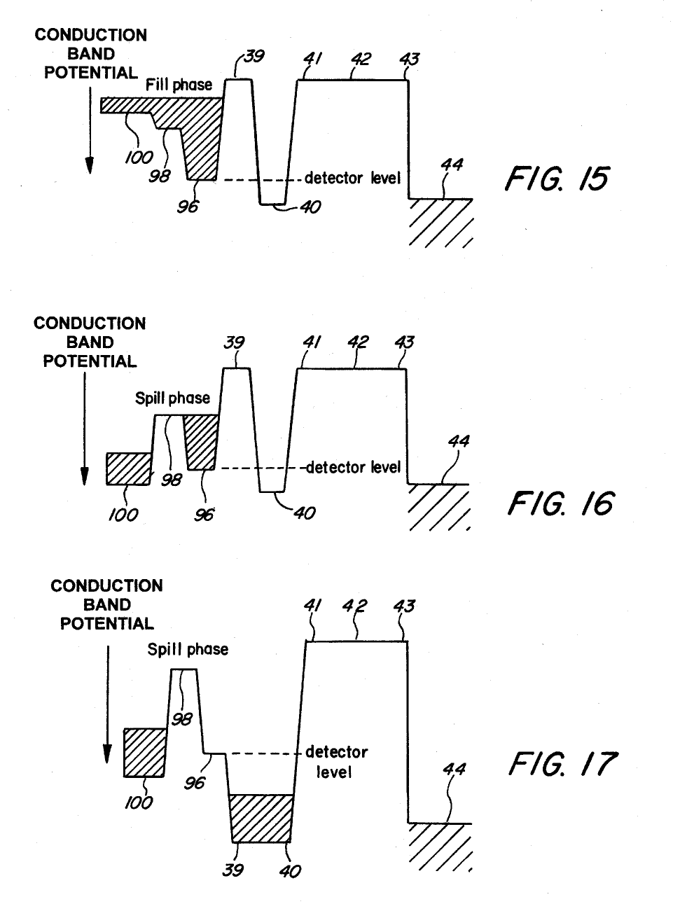

The charge-transporting circuit 14 may include a plurality of gates or electrodes to transport charge across the low noise readout apparatus 80. For example, the charge-transporting circuit 14 may include first gate 20, second gate 22 and floating gate 24. In one embodiment, the charge-transporting circuit 14 may also include third gate 18 and fourth gate 81. Fourth gate 81 is electrically connected to, i.e. at the same voltage as, the charge-generating unit 12 located in the first wafer. In that way, it creates a charge replica in the potential well 96 underneath the fourth gate 81 in the second wafer through a fill and spill mechanism. The gates 18, 20, 22 and 24 may be aligned in series and adjacent the potential well 96, as shown in FIG. 15. The first gate 20 may be configured to transfer charge from the potential well 96 to the second gate 22. The second gate 22 transfers the charge to the floating gate 24. Third gate 18 may be used to isolate the charge at the first gate 20 from the potential well 96.

The floating gate 24 is preferably initialized using a predetermined voltage potential from the readout circuit 15 (102). The readout circuit 15 may be coupled to the charge-transporting circuit 14 to measure a voltage corresponding to the charge transferred to the charge-transporting circuit 14. The readout circuit 15 may include reset transistor 25, supply voltage 27 and source follower transistor 28. The reset transistor 25 initializes the floating gate 24 using the supply voltage 27. After initialization, charge replica is transferred from charge-generating unit 12 to the floating gate 24, where it causes a potential change at node 29. The difference between the supply voltage 27 and the potential change at node 29 provides a corresponding readout voltage that is outputted via source follower transistor 28 to the output circuit 16. The second gate 22 transfers the charge replica to the floating gate 24 to generate a first corresponding readout voltage. The first gate 20, the second gate 22 and the floating gate 24 transfer the charge back and forth, at least once, to generate at least a second corresponding readout voltage.

In one embodiment, the output circuit 16 may include an averaging circuit (not shown) and an accumulation circuit (not shown). The averaging circuit may be configured to average the first corresponding readout voltage and the at least second corresponding readout voltage and outputs an average voltage. The accumulation circuit (not shown) may be configured to sum the first corresponding readout voltage and the at least second corresponding readout voltage and outputs a total voltage. Once the average or accumulation process is completed, charge may be drained from the low noise readout apparatus 10 using a charge drain 30 with reset gate 32. Charge drainage may be activated by coupling the charge drain 30 to a high potential, such as supply voltage 27. Therefore, the reset gate 32 is clocked to high, which allows the charge to flow from the floating gate 24 to the charge drain 30.

In one embodiment, the charge-transporting circuit 14 may be configured to generate a first charge replica in the potential well 96 using a fill and spill mechanism, transfer the first charge replica from the potential well 96, across the first gate 20, the second gate 22, and the floating gate 24 to generate the first corresponding readout voltage in the readout circuit 15, and transfer the first charge replica back and forth, at least once, from the floating gate 24 to the first 20 and second gates 22 to generate the at least second corresponding readout voltage in the readout circuit 15.

A fill and spill structure 82 in charge-transporting circuit 14 may be used to provide fill and spill mechanism. The fill and spill structure 82 generates a charge replica of the signal that was generated by charge-generating unit 12. The fill and spill structure 82 may include a fill voltage source V_{fill} 84 and a spill voltage source Vₛₚᵢₗₗ 86. To facilitate fill and spill mechanism, the charge-transporting circuit 14 may include an n+ implant 88, a barrier gate 90 and a detector bias 92 with reset switch 94. The detector bias 92 may be used, along with detector ground 93, to short out the charge-generating unit 12.

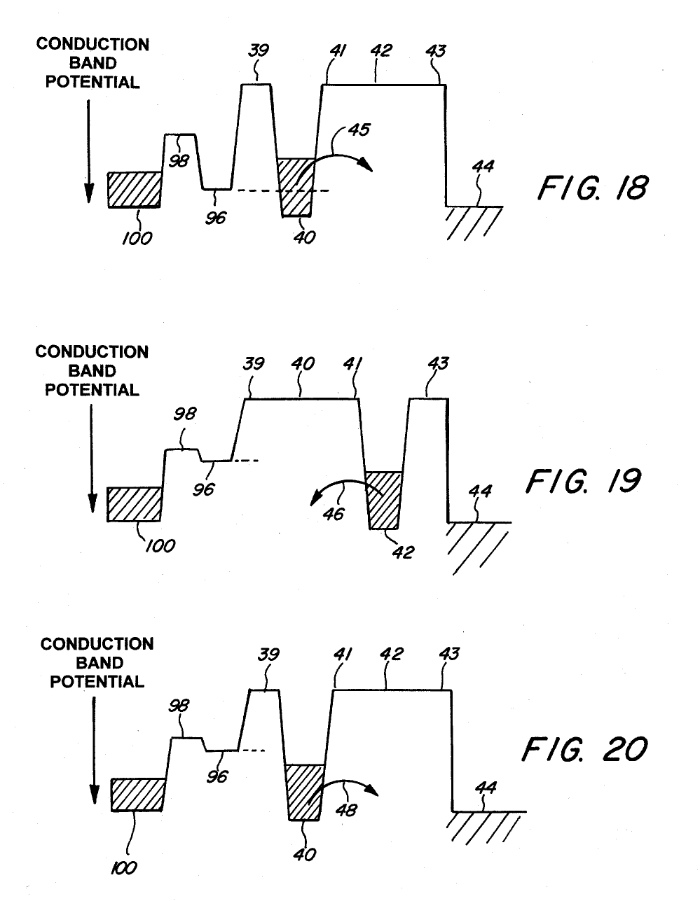

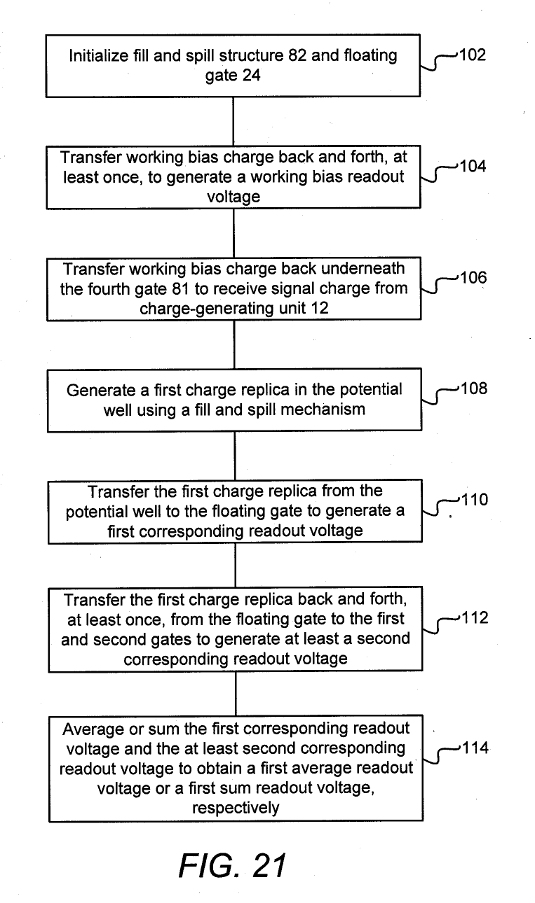

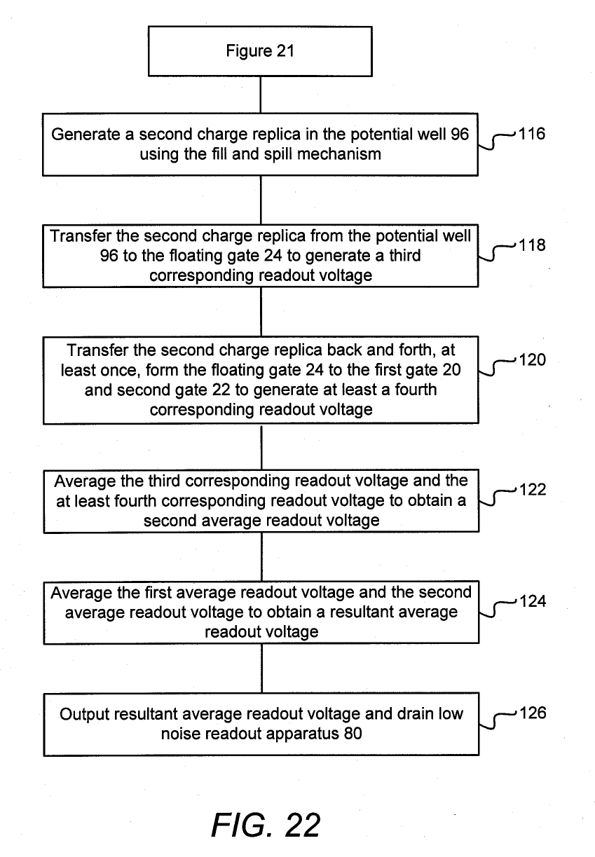

FIGS. 15-22 illustrate the charge transport in the low noise readout apparatus 80, according to an embodiment of the invention. FIGS. 15 and 16 illustrate the charge transport after integration, FIG. 17 illustrates a snap shot charge transport, while FIGS. 18-20 illustrate low noise multiple readout for the low noise readout apparatus 80.

According to one embodiment implementing the fill and spill mechanism, the voltage level of conduction band potential well 96 for the fourth gate 81 depends on a bias charge introduced by detector bias 92, the signal charge received from the charge-generating unit 12 and additional charge attributed to noise in the surroundings. By actuating the reset switch 94, the detector bias 92 introduces bias charge to the potential well 96 to initialize the fill and spill structure 82 (102). As shown in FIG. 15, the conduction band potential well 96 is deeper, in the fill phase, than the conduction bands 98 and 100 for barrier gate 90 and n+ implant 88, respectively. The conduction band 100 is lowered to transfer the charge to the potential well 96.

By controlling the voltage from fill voltage source V_{fill} 84 and spill voltage source Vₛₚᵢₗₗ 86, the conduction band 100 may be raised above conduction band 98, forming a trough for electrons underneath the n+ implant 88 and the fourth gate 81 and forming a potential peak for electrons underneath the barrier gate 90, as shown in FIG. 17. For example, the fill voltage source V_{fill} 84 may be fixed at a predetermined voltage while the spill voltage source Vₛₚᵢₗₗ 86 is adjusted to spill out the excess charge before readout. In the spill phase, a working electron bias charge falls in the trough underneath the fourth gate 81 while excess electron bias charge falls back into the trough underneath the n+ implant 88. The polarity of working charge, troughs and peaks in the previous description can be inverted by using holes instead of electrons by anyone skilled in the art and is part of the scope of the present invention.

As shown in FIGS. 18-20, the working electron bias charge may be transferred back and forth, at least once, to generate a working bias readout voltage (104). After integration, the working electron bias charge may be transferred back underneath the fourth gate 81 to spill part of the working electron bias charge as a result of the change in potential well level 96. This potential well level changes when light 17 strikes the charge-generating unit 12 (106). The difference between the original working electron charge and the working bias electron charge after this signal spill process is the signal charge replica (108). As shown in FIG. 18, the charge replica is then transferred from the potential well 96, across the first gate 20, the second gate 22, and the floating gate 24 to generate a first corresponding readout voltage (110). FIGS. 18-20 shows the charge replica transferring back and forth, at least once, to generate at least a second corresponding readout voltage (112). The first corresponding readout voltage and the at least second corresponding readout voltage may be averaged by the averaging circuit (not shown) to obtain a first average readout voltage or summed by the accumulation circuit (not shown) to obtain a first accumulated readout voltage (114).

In one embodiment, the charge-transporting circuit 14 may further be configured to generate a second charge replica in the potential well 96 using the fill and spill mechanism (116), transfer the second charge replica from the potential well 96, across the first gate 20, the second gate 22, and the floating gate 24 to generate a third corresponding readout voltage (118), and transfer the second charge replica back and forth, at least once, from the floating gate 24 to the first 20 and second gates 22 to generate at least a fourth corresponding readout voltage (120). The third corresponding readout voltage and the at least fourth corresponding readout voltage may be averaged by the averaging circuit (not shown) to obtain a second average readout voltage or summed by the accumulation circuit (not shown) to obtain a second accumulated readout voltage (122). The averaging circuit (not shown) may also be configured to average the first average readout voltage and the second average readout voltage to obtain a resultant average readout voltage (124). Once the average or accumulation process is finished, the charge replica may be drained from the low noise readout apparatus 80 using the charge drain 30 with reset gate 32 (126).

As can be envisioned by a person skilled in the art, the low noise readout apparatus 80 may provide ultra low light level imaging with sub-electron noise for hybrid detector arrays. In one embodiment, the low noise readout apparatus 80 may be used for star gazing camera or high speed image capture. The low noise readout apparatus 80 may also be used with a wide range of applications for image stabilization.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A low noise readout apparatus, comprising:
a complementary metal oxide semiconductor having a plurality of pixels, each pixel having a charge-generating unit configured to release a charge;
a potential well for receiving the released charge from the charge-generating unit;
a first gate, a second gate and a floating gate, in series and adjacent the potential well, the first gate transfers the charge from the potential well to the second gate, the second gate transfers the charge to the floating gate to generate a first corresponding readout voltage, the first gate, the second gate and the floating gate transfer the charge back and forth, at least once, to generate at least a second corresponding readout voltage; and
a readout circuit coupled to the floating gate, the readout circuit measures a voltage corresponding to the charge transferred to the floating gate.

2. The low noise readout apparatus of claim 1 further comprising an output circuit selected from a group consisting of an averaging circuit and an accumulation circuit, the averaging circuit is configured to average the first corresponding readout voltage and the at least second corresponding readout voltage and outputs an average voltage, the accumulation circuit is configured to sum the first corresponding readout voltage and the at least second corresponding readout voltage and outputs a total voltage.

3. The low noise readout apparatus of claim 1 wherein the charge-generating unit is selected from a group consisting of a photodiode, an avalanche photodiode, a pinned photodiode and a photo gate.

4. The low noise readout apparatus of claim 2 further comprising a reset switch and a charge drain to provide drainage for the charge after the average voltage or the total voltage is outputted.

5. The low noise readout apparatus of claim 1 further comprising a third gate between the first gate and the potential well, the third gate isolates the charge at the first gate from the potential well.

6. The low noise readout apparatus of claim 1 further comprising a deep p implant to shield the first gate, the second gate and the floating gate from parasitic charge integration.

7. The low noise readout apparatus of claim 1 wherein the charge-generating unit is located on a first wafer and the potential well, the first gate, the second gate, the floating gate, and the readout circuit are located on a second wafer, the first wafer being hybridized to the second wafer.

8. The low noise readout apparatus of claim 7 wherein the first wafer is selected from a group consisting of semiconductor compounds and alloys from groups 2 and 6 of the periodic table, semiconductor compounds and alloys from groups 4 and 6 of the periodic table, semiconductor compounds, elements or alloys from group 4 of the periodic table, semiconductor compounds and alloys from groups 3 and 5 of the periodic table.

9. The low noise readout apparatus of claim 7 further comprising a fill and spill unit for generating a charge replica in the potential well located in the second wafer.

10. A method for reducing noise readout in an image sensor, the image sensor having a charge-generating unit, a potential well, a first gate, a second gate, a floating gate and a readout circuit, the method comprising:
initializing the floating gate using a predetermined voltage potential from the readout circuit;
generating a charge when light strikes the charge-generating unit;
altering the depth of the potential well using the generated charge;
generating a first charge replica in the potential well using a fill and spill mechanism;
transferring the first charge replica from the potential well, across the first gate, the second gate, and the floating gate to generate a first corresponding readout voltage;
transferring the first charge replica back and forth, at least once, from the floating gate to the first and second gates to generate at least a second corresponding readout voltage; and
averaging the first corresponding readout voltage and the at least second corresponding readout voltage to obtain a first average readout voltage.

11. The method of claim 10 further comprising:
generating a second charge replica in the potential well using the fill and spill mechanism;
transferring the second charge replica from the potential well, across the first gate, the second gate, and the floating gate to generate a third corresponding readout voltage;
transferring the second charge replica back and forth, at least once, from the floating gate to the first and second gates to generate at least a fourth corresponding readout voltage;
averaging the third corresponding readout voltage and the at least fourth corresponding readout voltage to obtain a second average readout voltage;
averaging the first average readout voltage and the second average readout voltage to obtain a resultant average readout voltage; and
outputting the resultant average readout voltage from the readout circuit.

12. The method of claim 10 wherein the charge-generating unit is selected from a group consisting of a photodiode, an avalanche photodiode, a pinned photodiode and a photo gate.

13. The method of claim 11 further comprising the step of draining the charge after the resultant average readout voltage is outputted from the readout circuit.

14. The method of claim 10 further comprising the step of isolating the charge at the first gate from the potential well using a third gate located between the first gate and the potential well.

15. A low noise readout image sensor, comprising:
a complementary metal oxide semiconductor having a charge-generating unit configured to release a charge;
a potential well for receiving the released charge from the charge-generating unit;
a charge-transporting circuit and a readout circuit, the readout circuit is coupled to the charge-transporting circuit to measure a voltage corresponding to the charge transferred to the charge-transporting circuit, the charge-transporting circuit having a first gate, a second gate and a floating gate, the charge-transporting circuit is configured to:
generate a first charge replica in the potential well using a fill and spill mechanism,
transfer the first charge replica from the potential well, across the first gate, the second gate, and the floating gate to generate a first corresponding readout voltage in the readout circuit, and
transfer the first charge replica back and forth, at least once, from the floating gate to the first and second gates to generate at least a second corresponding readout voltage in the readout circuit; and
an averaging circuit for averaging the first corresponding readout voltage and the at least second corresponding readout voltage to obtain a first average readout voltage.

16. The low noise readout image sensor of claim 15 wherein the charge-transporting circuit is further configured to:
generate a second charge replica in the potential well using the fill and spill mechanism,
transfer the second charge replica from the potential well, across the first gate, the second gate, and the floating gate to generate a third corresponding readout voltage, and
transfer the second charge replica back and forth, at least once, from the floating gate to the first and second gates to generate at least a fourth corresponding readout voltage.

17. The low noise readout image sensor of claim 16 wherein the averaging circuit is configured to average the third corresponding readout voltage and the at least fourth corresponding readout voltage to obtain a second average readout voltage, and average the first average readout voltage and the second average readout voltage to obtain a resultant average readout voltage.

18. The low noise readout image sensor of claim 15 wherein the charge-generating unit is selected from a group consisting of a photodiode, an avalanche photodiode, a pinned photodiode and a photo gate.

20. The low noise readout image sensor of claim 15 wherein the charge-generating unit is located on a first wafer and the potential well, the charge-transporting circuit and the readout circuit are located on a second wafer, the first wafer being hybridized to the second wafer.
